(19) United States
(12) Patent Application Publication
(10) Pub. No.: US 2007/0205980 A1
(43) Pub. Date: Sep. 6, 2007

(54) MOBILE PROJECTABLE GUI

(75) Inventor: Patericus Dijk, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,633

(22) PCT Filed: Mar. 31, 2005
(86) PCT No.: PCT/IB05/51076

§ 371 Date: Oct. 4, 2006

(30) Foreign Application Priority Data
Apr. 8, 2004 (EP) 04101463.0

(51) Int. Cl. G09G 5/00

(52) U.S. Cl. 345/156

(57) ABSTRACT

A hand-held device creates a projection of visual information onto a surface under control of a stabilizing the projection for a motion of the device. The device has a component for creating in the stabilized projection a visual indicium that is moveable with respect to the projection under user control. This architecture enables the device to be configured as a remote control device.

### FIELD OF THE INVENTION

The invention relates to a hand-held device for creating a projection of visual information onto a surface.

### BACKGROUND ART

Such a device is known from, e.g., US Patent Application Publication 20030038928, herein incorporated by reference. The known device relates to the presentation of visual information using a handheld or wearable device. In one embodiment, a cell phone is modified to include a means for projecting an image onto a wall. Also integrated are a means to sense when the cell phone moves relative to the image on the wall, and to offset the relative movement through a means for stabilizing the image. This enables the user of the cell phone to produce and interact with a large visual media display while the size of the cell phone is not significantly increased.

### SUMMARY OF THE INVENTION

The inventor has realized that this known concept can be taken a step further to enable a synergetic combination of rendering and user-interaction. To this end, the inventor proposes a hand-held device with a functionality for creating a projection of visual information onto a surface. The projection is under control of a stabilizer for stabilizing the projection for a motion of the device. The device comprises a component for creating in the stabilized projection a visual indicium that is moveable with respect to the projection under user control. The qualifier “hand-held” refers to the mobile or portable character of the device during operational use. This architecture enables the integration of means for creating a graphical user interface of large dimensions for a handheld device that, almost by definition, has a small form factor.

In an embodiment of the invention, the component comprises a light-emitting part, e.g., a laser-pointer, whose orientation is fixed with respect to the device. In another embodiment, the component comprises a microcontroller for controlling the location of the indicium being a part of the projected visual information.

In a further embodiment, the device has a confirmation input for enabling the user to confirm a selection of a location in the projection occupied by the indicium. This configuration enables to use the projection as a graphical user interface (GUI) to, e.g., a file system for organized storage of electronic files on the device (PDA, MP3 player, etc.).

In a further embodiment, the device has a communicator for communicating the confirming of the selection to a source external to the device. This configuration provides the device with the functionality of, e.g., a remote controller for enabling remote control of an operation of the source by associating a position of the indicium with a selectable item represented in the projection. Confirming the position initiates the sending of the proper remote control command. As another example of this configuration, the device has a browser and the communicator enables wireless access to a data network. Navigating on the Internet and clicking hyper-links are accomplished by confirming the selection as described above.

In another embodiment, the device is configured for playing a computer game for which the projection forms a visual feedback. The component comprises a microcontroller for controlling the location of the indicium being a part of the projected visual information. The indicium may comprise an animation or animated character for interacting with a virtual world represented by the projection.

In yet another embodiment, the device comprises a display monitor. The projection capabilities may be useful when the visual information is of too high a resolution to be discerned when the information is rendered at the display monitor.

The visual indicium may serve, e.g., to guide the attention of an audience to a specific feature when discussing or presenting the visual information. The indicium may also function as an aid for interacting with the information represented in the projection.

### BRIEF DESCRIPTION OF THE DRAWING

The invention is explained in further detail, by way of example and with reference to the accompanying drawing wherein:

FIGS. 1, 2 and 3 are block diagrams of a device in the invention;

FIGS. 4, 5 and 6 illustrate manners to determine the screen position of the indicium for several embodiments.

Throughout the figures, same reference numerals indicate similar or corresponding features.

### DETAILED EMBODIMENTS

In the following embodiments, the device according to the invention is for example comprised in, or comprises, a PDA, a cell phone, a still picture or video camera, a portable music player, a remote control device, a computer gaming device, etc., or another mobile device typically handheld or wearable in operational use.

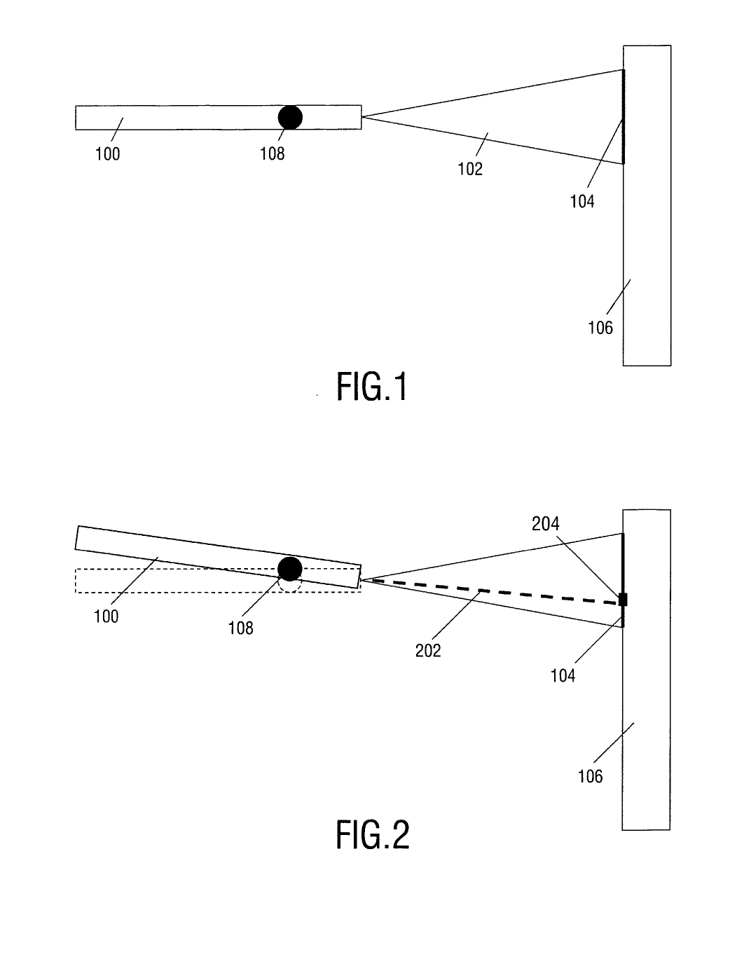

FIGS. 1 and 2 are diagrams illustrating operational use of a handheld device 100 in the invention. FIG. 1 shows device 100 in a first operational mode, emitting a beam of light 102 to create a projection 104 of visual information on a wall 106. Projection 104 is stabilized for, e.g., undesired vibrations of the user's hand in a manner known from, e.g., US Patent Application Publication 20030038928 and from the documents referred to therein. This type of stabilization neutralizes, or at least reduces, in projection 104 the vibrations, to which device 100 is being subjected as it is hand-held. Typically, these vibrations are characterized by a certain magnitude of amplitudes and by a certain range of frequencies. FIG. 2 shows device 100 in a second operational mode. Mode selection is accomplished through user interaction with, e.g., a mode selection button 108 at device 100 or through some other suitable means such as speech control, a timer that switches from the first to the second mode after a time period has elapsed wherein device 100 has been kept relatively still, etc. Device 100 in FIG. 2 keeps on projecting the visual information on wall 106, but now stabilization of the projection is also required for movements larger than unintentional vibrations. Within practical limits, the user changes the position and orientation of device 100 in order to move the indicium across the projected image 104. The stabilization of the projection is now also to respond to these movements intentionally imposed on device 100 by the user's hand. This movement has typically larger amplitudes and lower frequencies than that of the unintentional vibrations. Device 100 now generates a narrow light beam 202 to create a visual indicium 204 on wall 106 for indicating certain features in projection 104 caused by beam 102. To implement this functionality, device 100 has, for example, an onboard laser pointer (not shown) or another light emitting component (not shown), whose orientation and position is fixed with respect to the housing of device 100. Alternatively, the pointer functionality is implemented by controlling the location of the indicium in software. For example, in the second mode, the indicium is generated as a cluster of pixels overlaid over the projected image or as an MPEG-7 object among other MPEG-7 objects making up the image to be projected, and the movement of the cluster is controlled by software so that e.g., this cluster is not subjected to the stabilizing operation. That is, the cluster follows the movement of device 100 as if the cluster were projected by a separate light source fixed with regard to device 100. As known, MPEG-7 models audio-visual data as a composition of objects, whose processing can be individually controlled.

Within practical limits, the user changes the position and orientation of device 100 in order to move the indicium across the projected image 104. The stabilization of the projection is now also to respond to the movement intentionally imposed on device 100 by the user's hand. This movement has typically larger amplitudes and lower frequencies than those of the unintentional vibrations.

In the second mode device 100 is used, for example, to present the visual information to one or more other persons. The pointer mode then enables the user to draw attention to certain features in the projection by the moveable indicium. Alternatively, the second mode enables the user to interact with the information as projected. For example, device 100 projects the image, e.g., of a web page that comprises clickable links, or of an organizational structure such as visualized in a Windows Explorer menu that shows a menu listing several selectable options. In the latter scenario, a selection of a link or of a menu option is accomplished by means of correlating the position of the indicium with the position of the link, or of the menu option, in the projected image when the user confirms his/her selection. Within the context of this correlating, see, for example, US Patent Application Publication 20030030622, herein incorporated by reference. This publication discloses various manners for determining the position of the indicium relative to the image projected. In another example of usage, the second mode of device 100 is used in a computer game or video game wherein the indicium is used to, e.g., target moving objects in the projection.

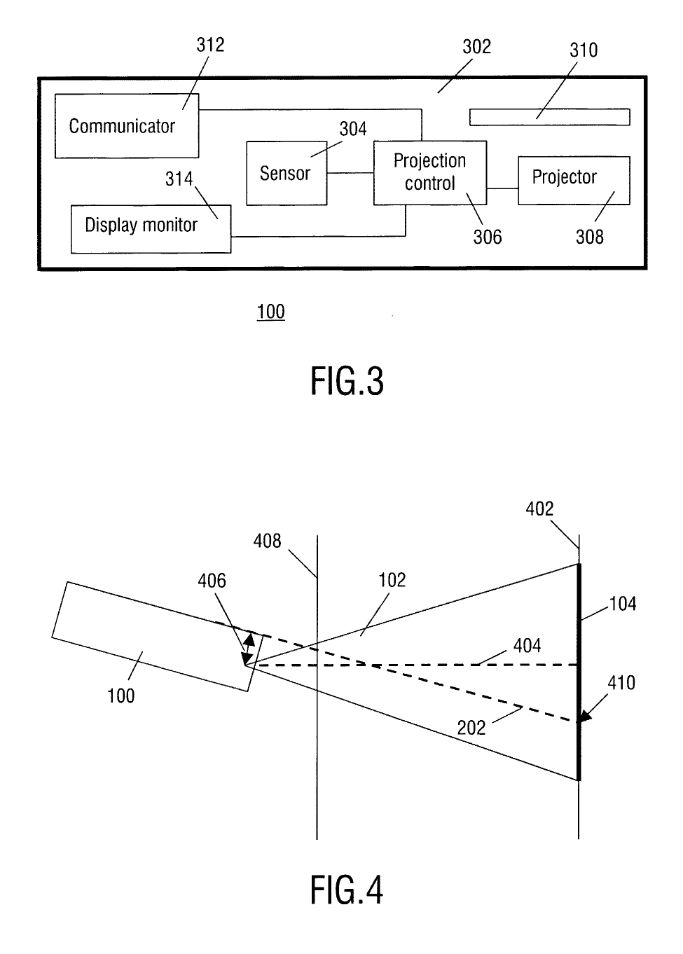

FIG. 3 is a block diagram for an implementation of device 100. Device 100 comprises a housing 302 accommodating one or more sensors 304 for sensing the orientation of device 100, e.g., relative to a reference orientation and/or relative to the earth's gravitational field, relative to projection 104, etc. For examples of sensor 304 see, e.g., US Patent Application Publication 20030038928 mentioned above. Housing 302 further accommodates a projection controller 306 and a projector 308. Sensor 304 provides input to projection controller 306 for control of projector 308 in order to stabilize projection 104 for movements of housing 302. Device 100 comprises a component 310 for creating in stabilized projection 104 a visual indicium that is moveable with respect to projection 104 under user control. Component 310 is mounted in, or on, housing 302 in such a manner that the orientation of its light beam 202 is fixed with regard to housing 302. Manipulating housing 302 then causes the indicium to move across projection 104 in a manner as if the indicium were a physical extension of housing 302.

In an embodiment of the invention, the indicium is used to interact with projection 104 and to communicate a result of this interaction to an external source (not shown). Device 100 then comprises a communicator 312 for communication between device 100 and the source. For example, device 100 is a remote control device and projection 104 comprises a menu of selectable options for controlling a source that comprises a remotely controllable apparatus such as a TV, a DVD player, etc. Selecting a specific menu option is accomplished by means of placing the indicium over the option in projection 104 and confirming selection through another user interaction with device 100, e.g., pressing a button. Confirmation then causes communicator 312 to send the associated control command via infrared (IR) or radio frequency (RF) electromagnetic waves to the source. As another example, device 100 has wireless Internet access via communicator 312 and comprises a browser. Projection 104 comprises the image of a Web page with a hyperlink. Device 100 enables the user to position the indicium over the location of the link in projection 104 and to initiate the click on the link, e.g., by pressing a button. This causes the relevant URL to be communicated to the wireless access point and the corresponding new Web page to be retrieved, both via communicator 312. Device 100 may also comprise a display monitor 314. Projector 308 is then used, e.g., if the visual information has a resolution too high to be viewed comfortably using display 314 that has a small form factor.

For all this to work, the location of the indicium is to be determined relative to projection 104 when the user confirms the selection or clicks the link. FIG. 4 is a diagram illustrating a way of doing this. It is assumed that only a limited accuracy is needed as menu options and clickable links occupy an area of a finite magnitude in projection 104 on a surface 402, the area of a link or of an option being larger than the area occupied by the indicium. It is further assumed that projection 104 is stabilized by means of maintaining an optical axis 404 of beam 102 substantially perpendicular to a surface 402. The latter is a reasonable assumption regarding operational use, as a substantially oblique projection will distort the image as projected. Device 100 is shown in FIG. 4 as tilted and/or panned while projecting an image on surface 402 giving rise to projection 104. The position of component 310 relative to projector 308 is fixed and known.

First consider the case (not illustrated) wherein the construction of component 310 is such that its position and that of projector 308 could be considered to coincide. That is, there is no offset between the sources of beam 102 and beam 202. Beam 202 coincides with optical axis 406 when device 100 is being held perpendicular to surface 404 in the first mode. The location of the indicium is fully determined by the tilt and pan angles of device 100 relative to optical axis 404 when stabilized. This follows from the fact that the distance between device 100 and surface 402 does then not affect the location of the intersection of beam 202 with projection 104 relative to the image. If it did, the image itself as projected would get distorted non-uniformly if the distance were changed. Accordingly, the tilt and pan angles derived from the stabilizing operation, can be converted into coordinates relative to the image to thus select the relevant menu option or clickable link. Now consider the case wherein the construction of component 310 is such that the positions of the light sources of component 310 and projector 308 have an offset relative to one another. Consider a lateral offset 406 as in FIG. 3. Beam 202 and optical axis 404 now run in parallel, but do not coincide, when axis 404 is held substantially perpendicular to surface 402 in the first mode. Then, the distance between device 100 and surface 402 does play a role. This is easily seen in the drawing by imagining surface 402 to be shifted into the position of a surface 408 closer by device 100. The point of intersection of beam 202 with projection 104 determines the coordinates of the item in the projected image pointed to by beam 202. These coordinates are now determined by the pan and tilt angles as well as the distance. The distance can be determined by focusing the image and taking the focal length as representative of the distance. Other manners to determine the distance may comprise a calibration step wherein the user confirms to device 100, e.g., by pressing a confirmation button, that beam 202 hits a calibration mark 410 in the stabilized projected image. From the pan and tilt angles, offset 406 and the relative position of mark 410 in the image one can estimate the distance. Similar considerations apply in the case wherein the sources of beams 102 and 202 have an axial offset (one lies behind the other). If lateral offset 406 is small with respect to the distance between device 100 and surface 402, the distance plays only a minor role, if at all, in accurately positioning the indicium under practical conditions.

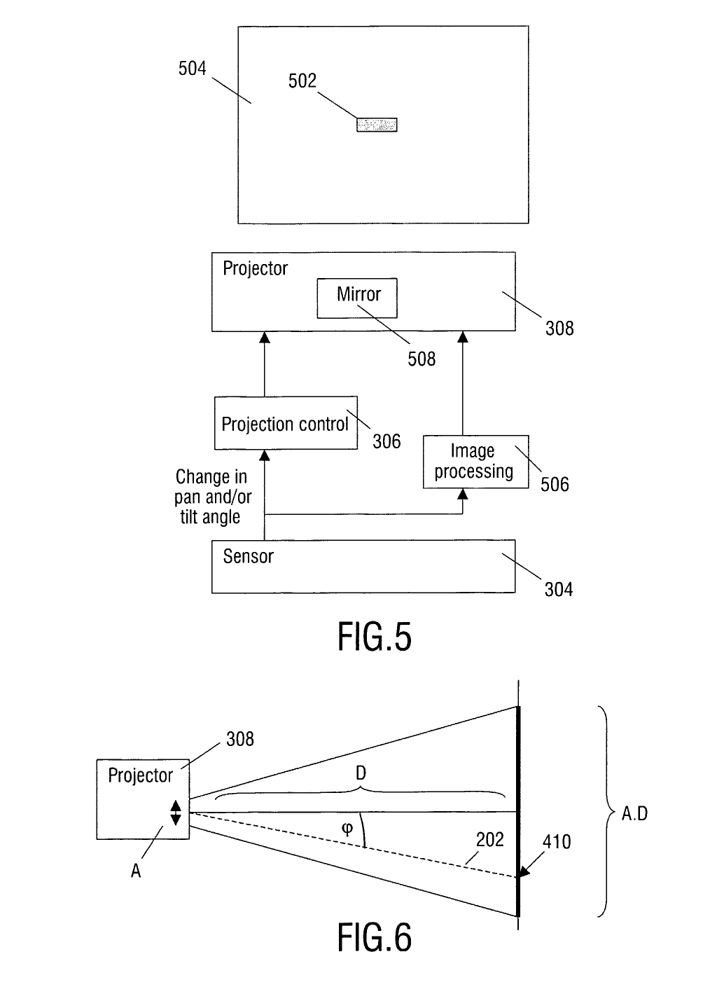

FIG. 5 is a diagram illustrating yet another embodiment of the invention, wherein the movement of an indicium 502 is controlled in software. Both an image 504 and indicium 502 are projected on wall 106 by projector 308. Indicium 502 is generated as a cluster of pixels overlaid over image 504 or as an MPEG-7 object among other MPEG-7 objects making up image 504 to be projected. To this end, device 100 comprises an image processor 506. Image 504 minus indicium 502 is subjected to the stabilizing operation from projection control 306 in the second mode of device 100 as discussed above. Indicium 502 is to follow instead the movement of device 100 in the second mode as if indicium 502 were a spot generated by, e.g., a laser pointer fixed to device 100. Assume that in the second mode, the position of indicium 502 is initialized to be in the center of image 504. A change in the pan angle and/or tilt angle of device 100 as detected by sensor 304 causes projection 104 of image 504 to be changed accordingly to counteract this change, e.g., by controlling a the movement of a mirror 508 in projector 308. As indicium 502 is part of image 504 as projected, indicium 502 would be subjected to the same operation keeping it were it was. Therefore, processor 506 moves indicium 502 in image 504 so as to neutralize the stabilizing counteraction. Within this context, reference is made to U.S. patent application Ser. No. 09/823,460 (Attorney docket US 018037) filed Mar. 30, 2001, for Nancy Kidney et al., for ONE-TO-ONE DIRECT COMMUNICATION, published under PCT as WO02079969 and incorporated herein by reference. This document relates to graphically representing the progress of the transfer of an electronic object from a sending handheld to a receiver as an object gradually sliding out of view on the display of the sender and gradually sliding into view on the display of the receiver. A gravity sensor in the handheld is used to determine the transmission's data rate. This visual feedback is an ergonomic feature for, e.g., electronic toys.

The operation referred to in the discussion of FIG. 5 is illustrated in FIG. 6. Assume that a linear size of the area of image 504 at projector 308 is known to be of magnitude “A”. Then, the linear size of projection 104 is “A.D”, wherein “D” is the distance between projector 308 and surface 106. Assume a tilt or pan angle φ of device 100 that intends to indicate the new position of the projection of indicium 502. If there was no image stabilization, projection 104 of image 504 would assume a position with its center i.e., the initial location of the projection of indicium 502, at point 410. As projection 104 is stabilized for this movement projection 104 does not follow the movement that establishes angle φ. However, the projection of indicium 502 is to assume the position of point 410. This position is a distance D.φ off the center (angle φ in radians) of projection 104 of size A.D. If indicium 502 in image 504 is moved to a distance φ off center of image 504, their compound projection results in the stabilized situation with the projection of indicium 502 assuming the position that the user intends it to assume. Accordingly, image processor is to be supplied by the values of the tilt and pan angles as sensed in order to move indicium 502 in image 504 in order to have the latter used as a pointer.

1-12. (canceled)

13. A hand-held device having a functionality for creating a projection of visual information onto a surface under control of a stabilizer for stabilizing the projection for a motion of the device, the device comprising a component for creating in the stabilized projection a visual indicium that is moveable with respect to the projection under user control of an orientation of the device, wherein the component comprises a controller for controlling the location of the indicium being a part of the projected visual information.

14. The device of claim 13, comprising a confirmation input for confirming a selection of a location in the projection occupied by the indicium.

15. The device of claim 14, comprising a communicator for communicating the confirming of the selection to a source external to the device.

16. The device of claim 14, comprising a remote controller for enabling remote control of an operation of the source by associating a position of the indicium with a selectable item represented in the projection.

17. The device of claim 14, comprising a browser and wherein the communicator enables wireless access to a data network.

18. The device of claim 14, comprising a file system for organized storage of electronic files.

19. The device of claim 13, configured for playing a computer game for which the projection forms a visual feedback.

20. The device of claim 19, wherein the indicium comprises an animation.

21. The device of claim 13, comprising a display monitor.
